(19) United States
(12) Patent Application Publication
(10) Pub. No.: US 2019/0370922 A1
(43) Pub. Date: Dec. 5, 2019

(54) PRICE-AWARE REAL-TIME AUCTION-BASED RIDE-SHARING SYSTEM

(71) Applicant: UNIVERSITY OF SOUTHERN CALIFORNIA, Los Angeles, CA (US)

(72) Inventors: Mohammad Asghari, Los Angeles, CA (US); Cyrus Shahabi, Los Angeles, CA (US); Ugur Demiryurek, Los Angeles, CA (US); Dingxiong Deng, Los Angeles, CA (US)

(21) Appl. No.: 16/341,654

(22) PCT Filed: Oct. 27, 2017
(86) PCT No.: PCT/US2017/058866

§ 371 Date: Apr. 12, 2019

Related U.S. Application Data
(60) Provisional application No. 62/413,838, filed on Oct. 27, 2016.

(51) Int. Cl. G06Q 50/30; G06Q 30/08; G06Q 10/02; G06Q 10/06

(52) U.S. Cl. CPC G06Q 50/30; G06Q 10/067; G06Q 10/02; G06Q 30/08

(57) ABSTRACT

Methods, systems, and apparatus for matching a driver associated with a driver timetable and a rider associated with a ride request including a detected rider location and a rider destination. The system includes a synchronizing server configured to transmit the ride request to a driver device. The driver device is configured to determine a driver value associated with incorporating the ride request into the driver timetable. The driver device is also configured to communicate, to the synchronizing server, the driver value. The synchronizing server is also configured to receive one or more other values from one or more other driver devices. The synchronizing server is also configured to determine a prime value from the one or more values, the prime value being the driver value. The synchronizing server is also configured to communicate, to the driver device, an indication to incorporate the ride request into the driver timetable.

### CROSS REFERENCE TO RELATED APPLICATIONS

This application claims the benefit and priority of U.S. Provisional Application Ser. No. 62/413,838, filed Oct. 27, 2016, entitled “Price-Aware Real-Time Auction-Based Ride-Sharing System,” the contents of which are herein incorporated by reference in its entirety.

### GOVERNMENT LICENSE RIGHTS

This invention was made with United States government support under Contract Nos. U.S. Pat. No. 1,115,153 and IIS1320149 awarded by the National Science Foundation. The United States government has certain rights in this invention.

### BACKGROUND

### 1. Field

This specification relates to systems and methods for facilitating scheduling of rides in a ride-sharing platform.

### 2. Description of the Related Art

Real-time ride-sharing, as an alternative transportation service, alleviates traffic congestion and decreases auto emissions. With the emergence of many commercial platforms, which automatically match drivers and riders on-the-fly, real-time ride-sharing has become more and more popular. Enabled by the development and technology advances of smart phones and location-based services, conventional ride-sharing platforms typically operate as follows: (1) Riders and drivers can join the platform via their smart phones, (2) a rider can submit a request, which consists of the pick-up and drop-off points, to the platform, (3) once a new request is received, the platform determines a driver (even en-route) to pick up the rider, (4) when the trip is completed, the platform calculates the rider's fare and the driver's income.

With these platforms, one rider can share a vehicle with another rider with a reduced trip cost (hereinafter “ride-pooling”) while enjoying fast and convenient transportation. However, many challenges exist to enable such real-time ride-sharing platforms capable of facilitating ride-pooling. From a business point of view, the platform provider seeks to maximize its own profit. However, higher profits should not be at the cost of either charging passengers more or paying drivers less than what would compromise participation and retention due to lack of monetary incentive for either party. Consequently, the design of a fair pricing model becomes an essential business strategy. This is particularly important in cases of ride-pooling.

### SUMMARY

What is described is a method for matching a driver associated with a driver schedule and a rider associated with a ride request including a rider location and a rider destination. The method includes communicating, from a server to a client device associated with the driver, the ride request. The method also includes determining, by the client device, a driver bid representing a value associated with incorporating the ride request into the driver schedule. The method also includes communicating, from the client device to the server, the driver bid. The method also includes receiving, by the server, one or more other bids from one or more other client devices associated with one or more respective other drivers. The method also includes determining, by the server, a winning bid from the one or more bids, the winning bid being the driver bid. The method also includes communicating, to the client device, an indication to incorporate the ride request into the driver schedule.

A system for matching a driver associated with a driver schedule and a rider associated with a ride request including a rider location and a rider destination is disclosed. The system includes a server configured to communicate the ride request to a client device associated with the driver. The system also includes the client device associated with the driver. The client device associated with the driver is configured to determine a driver bid representing a value associated with incorporating the ride request into the driver schedule. The client device associated with the driver is also configured to communicate, to the server, the driver bid. The server is also configured to receive one or more other bids from one or more other client devices associated with one or more respective other drivers. The server is also configured to determine a winning bid from the one or more bids, the winning bid being the driver bid. The server is also configured to communicate, to the client device, an indication to incorporate the ride request into the driver schedule.

A computing device for matching a driver and a rider associated with a ride request including a rider location and a rider destination is disclosed. The computing device is configured to receive, from a mobile computing device associated with the rider, the ride request. The computing device is also configured to receive, from a plurality of mobile computing devices each respectively associated with a plurality of drivers, a respective location of each driver. The computing device is also configured to determine a set of eligible drivers from the plurality of drivers for servicing the rider based on the respective location of each driver of the plurality of drivers. The computing device is also configured to communicate the ride request to a set of mobile computing devices each respectively associated with the set of eligible drivers. The computing device is also configured to receive, from each mobile computing device respectively associated with the set of eligible drivers, a respective driver bid. The computing device is also configured to determine a winning driver bid associated with a winning driver. The computing device is also configured to communicate, to a mobile computing device associated with the winning driver, an indication to incorporate the ride request into a driver schedule associated with the winning driver.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIGS. 1A-1D illustrate an exemplary process of the price-aware real-time auction-based ride-sharing system, according to various embodiments of the invention.

FIG. 2A illustrates an example driver profile, according to various embodiments of the invention.

FIG. 2B illustrates an example rider profile, according to various embodiments of the invention.

FIGS. 3A-3B illustrate possible ways to incorporate a new rider into an existing driver schedule, according to various embodiments of the invention.

FIGS. 4A-4D illustrate the process of determining eligible drivers in range of the rider, according to various embodiments of the invention.

FIGS. 5A-5D illustrate the process of determining a driver bid, according to various embodiments of the invention.

FIG. 6 illustrates an example process of determining a best schedule with two requests, according to various embodiments of the invention.

FIG. 7 illustrates an exemplary price-aware real-time auction-based ride-sharing system, according to various embodiments of the invention.

FIG. 8 illustrates an example process of the price-aware real-time auction-based ride-sharing system, according to various embodiments of the invention.

FIG. 9 shows different values used for various parameters to evaluate the framework of the price-aware real-time auction-based ride-sharing system, according to various embodiments of the invention.

FIGS. 10A-10D illustrate comparisons of the price-aware real-time auction-based ride-sharing system and other approaches, according to various embodiments of the invention.

FIGS. 11A-11D illustrate comparisons of the price-aware real-time auction-based ride-sharing system and other approaches, according to various embodiments of the invention.

FIGS. 12A-12D illustrate comparisons of the price-aware real-time auction-based ride-sharing system and other approaches, according to various embodiments of the invention.

FIGS. 13A-13D illustrate comparisons of the price-aware real-time auction-based ride-sharing system and other approaches, according to various embodiments of the invention.

FIGS. 14A-14B illustrate comparisons of the price-aware real-time auction-based ride-sharing system and other approaches, according to various embodiments of the invention.

FIG. 15 illustrates comparisons of the price-aware real-time auction-based ride-sharing system and other approaches, according to various embodiments of the invention.

FIG. 16 illustrates comparisons of the price-aware real-time auction-based ride-sharing system and other approaches, according to various embodiments of the invention.

### DETAILED DESCRIPTION

Real-time ride-sharing, which enables on-the-fly matching between riders and drivers (even en-route), is an important technology due to its environmental and societal benefits. With the emergence of many ride-sharing platforms, the design of a scalable framework to match riders and drivers based on their various constraints while maximizing the overall profit of the platform may be a distinguishing feature of a platform.

A key challenge of such framework is to satisfy both types of the users in the system, e.g., reducing both riders' and drivers' travel distances. However, the existing approaches focus on minimizing the total travel distance of drivers, which is not always equivalent to shorter trips for riders. The systems and methods described herein represent a fair pricing model that simultaneously satisfies both the riders' and drivers' constraints and desires (represented by their profiles).

In particular, the systems and methods described herein include a distributed auction-based framework where each driver's mobile app automatically bids on every nearby request, taking into account many factors, such as both the driver's and the riders' profiles, their itineraries, the pricing model, and the current number of riders in the vehicle. Subsequently, the server determines the highest bidder and assigns the rider to that driver. This framework is scalable and efficient, processing hundreds of tasks per second in the presence of thousands of drivers.

Experimental results show that the framework of the systems and methods described herein can simultaneously match more riders to drivers (i.e., achieve a higher service rate) by engaging the drivers more effectively. Moreover, the framework schedules shorter trips for riders (i.e., better service quality). Finally, as a consequence of higher service rate and shorter trips, the framework increases the overall profit of the ride-sharing platforms.

The algorithm is different from any other dispatch/ride sharing application/algorithms in at least the following ways: 1) The algorithm uses an auction-based framework to match the riders and drivers in the ride sharing applications; and 2) The algorithm allows the riders and drivers to define their profiles. For example, from the riders' side: wait no more than 5 minutes, and from drivers' side: drive at most 4 hours/100 miles during the day, etc. 3) The profiles of the drivers and riders are matched automatically by the algorithm, enabling maximum possible gain for drivers, riders and the service provider; and 4) The algorithm enables dynamically re-routing of drivers as new requests enter the system with minimum cost to the driver's and riders constraints.

Even though ride-pooling reduces the riders' cost, it incurs extra distance (i.e., detour) for riders. While each rider's fare should be discounted as a function of the length of the detour, the driver should be rewarded more as the total travel distance is increased due to all detours. Furthermore, different users (i.e., riders and drivers) might value their time differently. Therefore, a fair pricing model should be available to both riders and drivers to express, for a certain amount of detour, how much discount or compensation they expect. Finally, in addition to fair pricing scheme for riders and drivers, the model should account for the provider's revenue as well.

An additional challenge of a ride-sharing platform is to process incoming requests in real-time. This involves two different tasks: i) checking which drivers can add the new requests (new pick-up and drop-off locations) to their current trip without violating the constraints of that trip (i.e., scheduling) and ii) selecting the best driver among those who can serve the new request (i.e., matching).

Processing the schedule of potentially thousands of drivers to check if they can accommodate a new request, with the additional task of matching their pricing profile with the incoming rider's profile, becomes computationally intensive. Therefore, the design of an efficient and scalable algorithm that assigns riders to drivers with a fair pricing model while maximizing the provider's revenue is challenging.

Conventional approaches focus on improving the efficiency of on-the-fly assignment with the objective of minimizing the total travel distance of drivers. In particular, in existing studies, a new request is assigned to a driver who can fit the request in his schedule with the least amount of increase in the total traveled distance. However, minimizing drivers' total travel distance is not always equivalent to overall shorter trips for riders. Consequently, when assigning a new request, the driver who would incur the minimum increase in total travel distance is not necessarily the most cost effective option. To illustrate, assume Driver A has two passengers on board and Driver B has only one. To serve an incoming request, A's incurred detour is 2 miles, while for B the detour is 3 miles. Even though A's detour is shorter, the platform owner has to compensate both passengers for 2 miles (a total of 4 miles) while in the case of B, it has to compensate only one passenger for a total of 3 miles. In addition, from the riders' perspectives, in the first scenario, two riders incur an extra detour, while in the second scenario, only one rider incurs an extra detour. A pricing model which incorporates defining monetary incentives for riders and drivers is novel and an improvement over the conventional approaches.

In addition to the conventional approaches' shortcomings from a monetary standpoint, in the conventional approaches, a centralized server is responsible for matching and scheduling incoming requests. With thousands of drivers in the system, even after applying a spatial index, the centralized server still needs to perform scheduling and profile matching for all the candidate drivers. With a large number of drivers, these conventional approaches fail to process new requests in real-time, and are therefore not scalable.

The systems and methods described herein address the aforementioned challenges. The systems and methods described herein include a general and versatile pricing model that allows both riders and drivers to set their monetary expectations for participating in ride-sharing based on their predefined profiles.

Specifically, each rider's profile defines the expected discount ratio for the detours incurred by ride-sharing. For example, one rider can express that the rider is willing to accept a 10 mile detour for 30% discount.

On the other hand, each driver's profile defines the expected cost in terms of the driver's total travel distance and time. The model also accounts for the revenue of the platform provider. Consequently, the objective of the system is to maximize the revenue of the ride-sharing framework while satisfying various temporal and monetary constraints of all users. The price-aware real-time auction-based ride-sharing system is price-aware because a new request is assigned to the driver who generates the highest profit. Since the pricing model of the price-aware real-time auction-based ride-sharing system is designed to compensate riders for detours, the most profitable choice is also the one in which riders incur the least amount of detour, resulting in better service quality. Finally, the price-aware real-time auction-based ride-sharing system also maximizes the revenue of the provider by increasing the service rate (throughput) in the system through engaging available drivers more effectively to serve more requests.

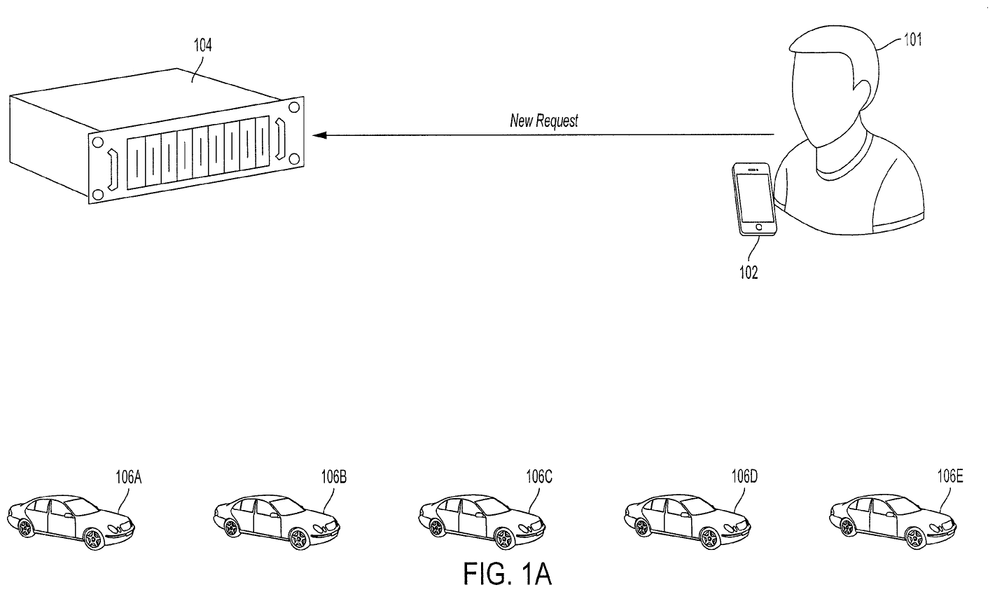

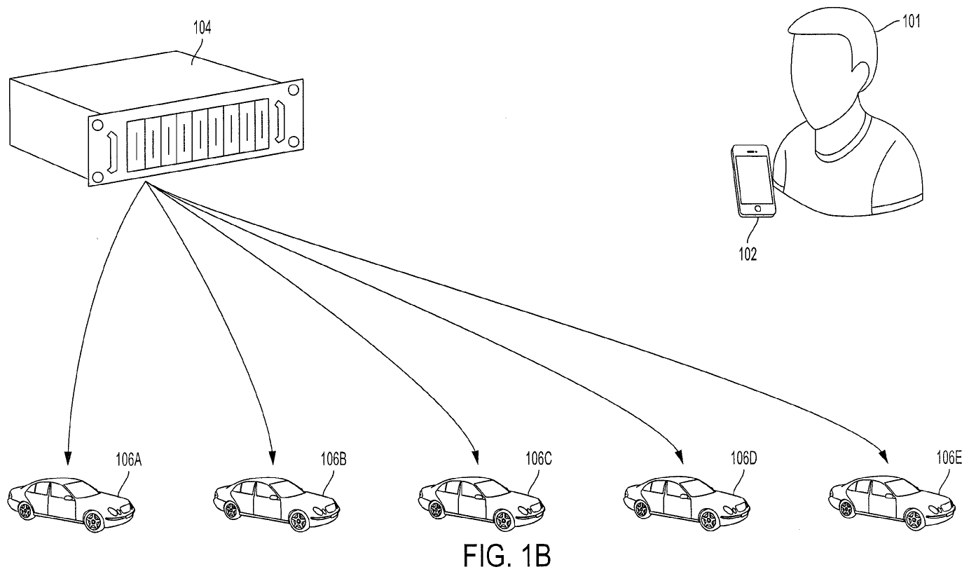

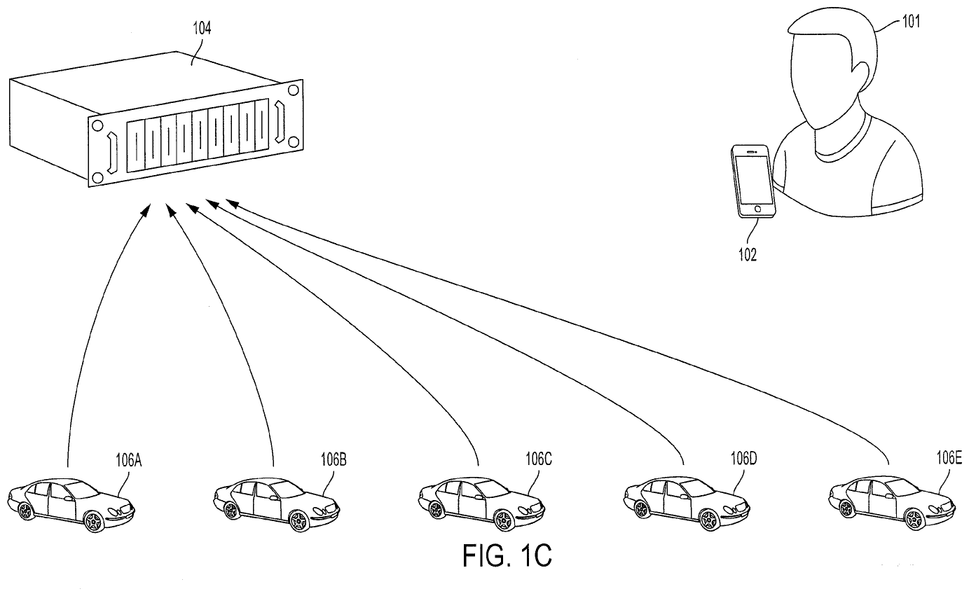

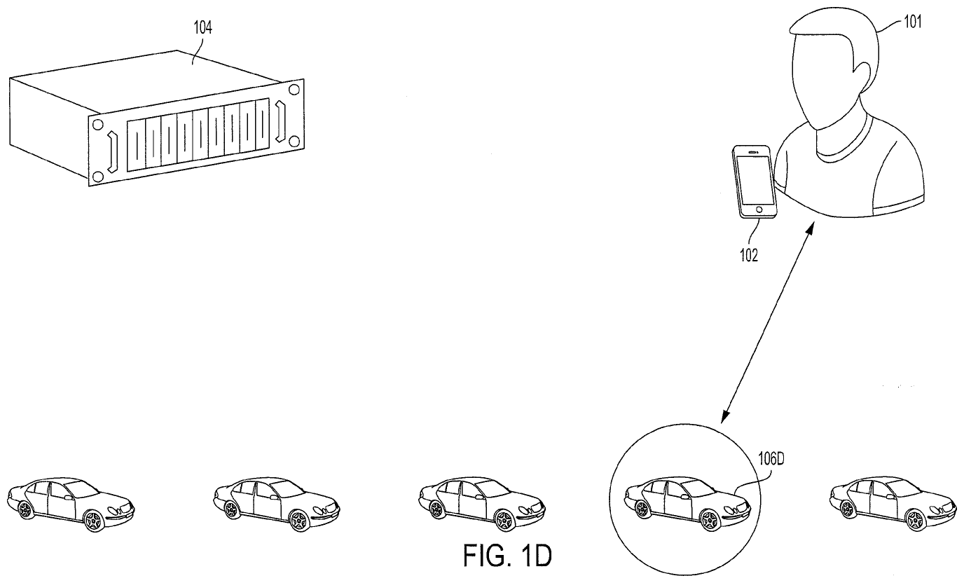

To efficiently assign riders to the candidate drivers, the systems and methods described herein include a distributed auction-based framework. As illustrated in FIG. 1A, a rider 101 sends a ride request to the server 104 via a rider mobile device 102 of the rider 101. The ride request includes a rider location, a rider destination, and a rider wait time. The server 104 receives the ride request from the rider mobile device 102.

As illustrated in FIG. 1B, the server 104 broadcasts the ride request to a set of driver mobile devices 106 associated with a respective set of candidate drivers. The driver mobile devices 106 each receive the ride request from the server 104. Each of the driver mobile devices 106 automatically computes a bid based on the driver's current schedule, the driver's profile, the rider profile of any riders currently in the driver's vehicle, and other spatiotemporal constraints. This bid is automatically generated by the driver's mobile device 106 and requires no input from the driver. In many embodiments, the bid is in terms of units of currency (e.g., dollars).

As illustrated in FIG. 1C, each of the driver mobile devices 106 submits its bid to the server 104. Accordingly, the server 104 collects all the bids from the driver mobile devices 106 of the candidate drivers and assigns the rider 101 to the highest bidding driver, as illustrated in FIG. 1D.

In some embodiments, each driver mobile device 106 performs a branch-and-bound algorithm that conducts an exhaustive search to determine whether the driver can fit a new request into the driver's current scheduling. Each driver carries a relatively small number of riders, so even an exhaustive search can be performed in real-time. Due to the distributed nature of the price-aware real-time auction-based ride-sharing system, all of the driver mobile devices 106 of the candidate drivers may perform the search in parallel. The server 104 simply selects the driver who generates the highest profit, and the rider 101 is assigned to that driver. Because of the distributed nature of the price-aware real-time auction-based ride-sharing system, there is no computational bottleneck at the server 104, and the price-aware real-time auction-based ride-sharing system is able to determine the most profitable drivers in real-time. This distribution of computing responsibilities is different from conventional systems, which require the server 104 to perform the calculations underlying the determination of which driver to assign to the rider. This unique and never-before-performed distribution increases the performance of the system and increases efficiency.

A rider's profile may be used as a tool for the rider to specify how much discount the rider expects to receive in return for a certain amount of detour on the rider's trip. The discount amount expected may be based on the detour length. The discount may be in percentage (e.g., 20% discount, 40% discount) or dollar amount (e.g., $5 discount, $10 discount). The detour length may be in terms of time based on traffic (e.g., 10 minute detour, 15 minute detour) or distance (e.g., 5 mile detour, 10 mile detour). A rider's profile can have different formats: linear decay or exponential decay, which represents that the rider is not willing to take a service after the decay point.

The rider may set time-based options further specifying expected discount. For example, the rider may expect more of a discount when the inconvenience of a detour is greater (e.g., heavy traffic, late at night). In an illustrative example, when the detour is between 12 AM-6 AM, the rider may expect a larger discount, as it is late at night and the rider may want to get home as soon as possible. In another illustrative example, when detour is between 3 PM-7 PM, the rider may also expect a larger discount, as there may be considerable traffic present, and a 2-mile detour may mean a 1 hour delay.

The rider may also set location-based options further specifying expected discount. For example, the rider may expect more of a discount when the detour goes through an area the rider does not want to go through. In an illustrative example, where a proposed detour takes the rider through a freeway, the rider may expect a larger discount, as the freeway may be congested and/or the particular rider prefers not to be in a car travelling at high speeds. In another illustrative example, where a proposed detour takes the rider through a more dangerous neighborhood, the rider may expect a larger discount.

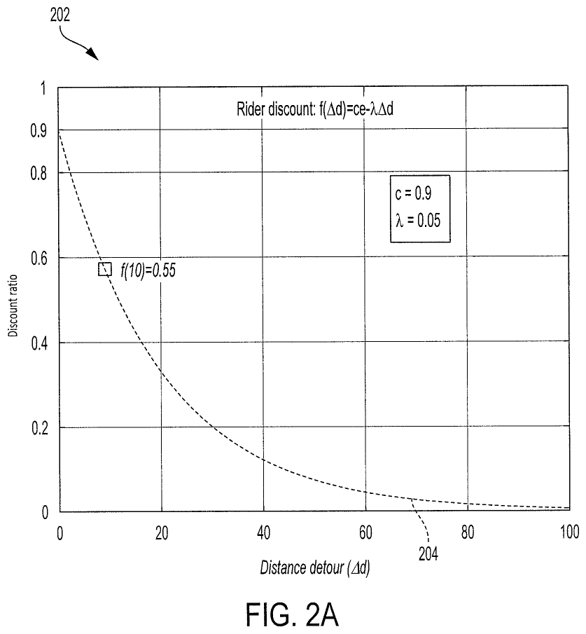

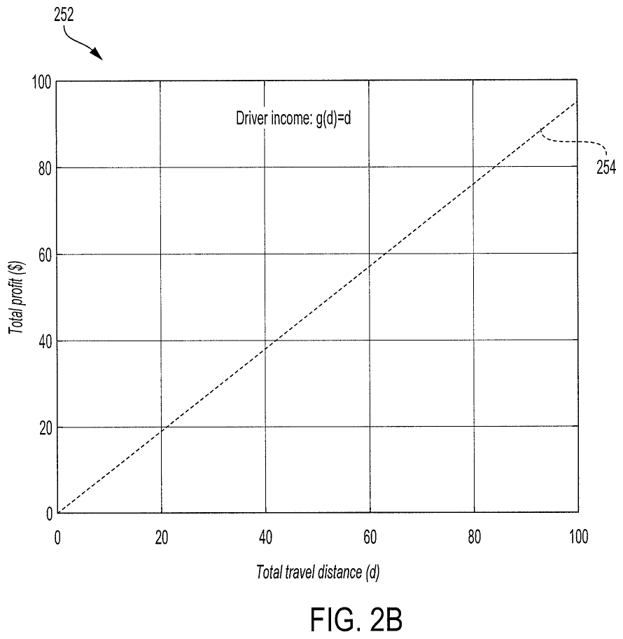

FIG. 2A illustrates an example of a rider's profile. In the rider profile 202, the horizontal axis represents a distance detour and the vertical axis represents a discount ratio. The curve 204 represents the values specified by the rider and is specific to the rider. For example, when the distance detour is 10 miles, the rider expects a discount ratio of 0.55. That is, if the rider is currently in a driver's vehicle, and the driver picks up another passenger resulting in a detour of 10 miles, the rider currently in the vehicle expects to pay 55% of the rider's original fare (i.e., a 45% discount).

The shape of curve 204 may be defined by the values c and λ, which may be specified by the rider, via a user interface of the rider mobile device 102. The curve 204 may take any shape desired by the rider. In some embodiments, the rider may simply enter in a plurality of data points (e.g., 5 mile detour results in 80% of original fare; 20 mile detour results in 20% of original fare; and 30 mile detour results in 1% of original fare) and the rider mobile device 102 may fit a curve to the entered-in data points.

Each driver has a unique profile which allows the driver to specify the cost of the driver's service. Similar to riders, drivers can have different expectations for participating in ride-sharing platforms. The drivers' profile allows them to set their expectations with respect to how much they expect to be paid for participating in the platform. The driver's profile can be any function. In fact, it can take any input in addition to the distance. For example, it is possible to define the driver's profile as a function based on travel distance, whereby the driver gets paid more for driving an additional amount of distance when picking up a rider for ride-pooling. Alternatively, it is possible to define the driver's profile as a function based on numbers of passengers, whereby the driver gets paid more for picking up additional passengers when picking up a rider for ride-pooling. Without loss of generality, as described herein, distance is used as the input of the driver's profile.

The expected compensation for the driver may be based on distance and/or time. The distance may be measured based on distance driven with a rider in the driver's vehicle. The time may be measured by time spent by the driver with a rider in the vehicle, which may better compensate a driver driving in traffic.

FIG. 2B illustrates an example of the driver's profile. In the driver profile 252, the horizontal axis represents a distance driven by the driver and the vertical axis represents a total profit. The curve 254 represents the values specified by the driver and is specific to the driver. For example, when the distance is 20 miles, the driver expects to make a profit of $20.

The driver may set time-based options further specifying expected compensation. The driver may expect more compensation when the driver's “shift” (time on duty) is longer than the driver had planned for it to be. For example, when the driver has driven for 10 straight hours, the driver may expect more compensation to keep driving. The driver's shift may vary and may be based on the day, week, month, etc.

In addition, the driver may expect more compensation at particular times of the day or night, which may be undesirable times to be driving. For example, when the driver is driving at peak traffic hours, the driver may expect more compensation, as the distance driven may be less than when in non-peak traffic hours. In another example, when the driver is driving late hours, the driver may expect more compensation.

Drivers may set income-based options further specifying expected compensation. In some embodiments, the driver may set a target amount of money to make on a given day, and the expected compensation may fluctuate based on the driver's progress toward the daily goal. For example, the driver may set a target of $500 in 10 hours on a given day, and the driver may have driven for 8 hours and made $300 so far. The driver will expect the driver's compensation per unit of time or distance to increase in order to meet the $500 goal, and the driver's expected compensation for the next two hours increases accordingly.

In some embodiments, the driver may set a minimum amount of money to make on a given day, and the expected compensation may fluctuate based on the driver's progress toward the minimum goal. For example, the driver may set a minimum target of $200 in 10 hours on a given day. The driver may have driven for 8 hours and made $50 so far, so in order to meet the $200 goal, the driver may have to be less picky about routes and passengers. The driver's expected compensation for the next two hours decreases accordingly, in order to increase volume of rides.

Whether the driver's expected compensation increases or decreases when a target goal is not expected to be met may be specified by the driver.

The driver may set location-based options further specifying expected compensation. The driver may expect more of a discount when the driver goes through an area the driver does not want to go through. For example, where a proposed route or proposed detour takes the driver through a freeway, the driver may expect increased compensation, as the freeway may be congested and/or the particular driver prefers not to be driving at high speeds. In another example, where a proposed detour takes the driver through a more dangerous neighborhood, the driver may expect increased compensation.

The driver profile may also include vehicle capacity. When vehicle capacity will be exceeded by incorporating a new ride request, no driver bid is submitted to the server.

A given road network may be represented as a graph G(V,E), where each node represents intersections, and each edge represents a road segment. Each edge (i,j)∈E(i,j∈V) is associated with a weight c(i,j), which is a travel cost (either in terms of time or distance) from i to j. The shortest path cost d(s,t) is defined as the minimal cost path connecting s and t. With the price-aware real-time auction-based ride-sharing system, time and distance can be converted from one to the other.

A ride request r may be represented as [symbol] s, e, w, ∈, F [symbol] consisting of a starting point s∈V and an end point e∈V. Each request also specifies w as the maximum time the rider can wait after making a request and the maximum detour ∈·d(s,e) the rider can afford. In addition, a rider's profile F:δd→[0, 1], specifies the relative discount in exchange for an incurred detour of δd.

Upon the acceptance of a ride request, the price-aware real-time auction-based ride-sharing system assigns the ride request to a driver. A driver v may be represented as [symbol] L, n, g [symbol] where L is the list of ride requests assigned to v, and n is the maximum number of ride requests v can accept at any point in time. A driver also has a profile g:d→$ which specifies the monetary cost of v driving a distance d while servicing its assigned requests.

Given a set L with n requests, a schedule S= [symbol] x₁, . . . , x₂ₙ [symbol] is an ordered sequence of pick-up and drop-off points for these request, where for each rᵢ∈L, rᵢ.s precedes rᵢ.e in S.

A schedule is valid for a driver v, if it satisfies the following conditions: (1) The riders' waiting time constraint: for any request rᵢ, the waiting time from the time the request is made until v arrives at rᵢ.s should be less than rᵢ.w. (2) The driver's capacity constraint: the number of riders in the vehicle cannot exceed the total capacity n. (3) Detour constraint: the maximum distance of every rider's trip should be less than (1+∈)·d(rᵢ.s, rᵢ.e). (4) The driver's and all riders' (the new rider and those already in the vehicle) monetary constraints.

The driver follows the sequence of picking up and dropping off riders. The schedule changes over time as riders are serviced (picked up or dropped off) and new requests are added to the schedule. In fact, adding a new request to a schedule can re-order some requests that already exist in the schedule. For example, when a new request r₃ arrives, the initial schedule of [symbol] s₁, s₂, e₁, e₂ [symbol] can be reordered to [symbol] s₁, s₂, s₃, e₂, e₃, e₁ [symbol] , where rider 1 is dropped off after rider 2.

Assuming a set of drivers V and a set of requests R, M⊂V×R may be referred to as matching if for each r∈R there is at most one u∈V such that (u, r)∈M, which may be referred to as a match. In a matching M, for every driver v, there exists a valid schedule Sᵥ, such that (v, rᵢ)∈M⇒rᵢ.s∈sᵥ∧rᵢ.e∈Sᵤ (or simply rᵢ∈Sᵤ).

A generic pricing model may be established such that for a given driver and the driver's schedule, the pricing model computes the final fare each rider has to pay, the income of the driver and the ride-sharing platform's profit. Subsequently, the ride-sharing problem may be defined as follows:

Given a set of ride requests R and a set of drivers V, the goal of the ride-sharing problem is to find a matching M between R and V such that the revenue of M is maximized.

The ride-sharing problem is NP-Hard since the Vehicle Routing Problem (VRP) is reducible to the ride-sharing problem in polynomial time. A globally optimal solution to the ride-sharing problem can be achieved when a Clairvoyant exists which knows what requests are going to be submitted to the framework at what time and also has the knowledge of which drivers are going to be available, in advance. However, this system is the online version of the problem, i.e., the framework has no knowledge regarding future requests and incoming requests have to be matched with drivers as soon as they are submitted to the framework. The optimality of online algorithms may be analyzed using competitive ratio, i.e., an algorithm A is called c-competitive for a constant c>0, if and only if, for any input I the result of A(I) is at most c times worse than the globally optimal solution. In the following, it is shown that no online algorithm can achieve a good competitive ratio for ride-sharing problem.

THEOREM 1. There does not exist a deterministic online algorithm for the ride-sharing problem that is c-competitive (c>0).

PROOF. Suppose there exists an algorithm A that is c-competitive. It is assumed there exists a Clairvoyant which knows every decision A makes. For simplicity, it is assumed there is only one driver at point (0; 0). The input starts with r₁ with a pick-up location at (w, 0) and r₂ with pick-up location at (−w, 0) (it is assumed all requests have a maximum wait time of w). The algorithm can make three choices for the driver. (1) move toward r₁, (2) move towards r₂ and (3) stay still. If choice 1 is selected, the Clairvoyant can generate the input such that at time t=1, n more request are submitted with pick-up location at (−w−1, 0) and drop-off locations similar to r₂. Similar arguments can be made if choice 2 or 3 are selected by the algorithm. A globally optimal solution can complete n+1 requests while A can at most complete one request. By adding more drivers far away in a similar situation, the Clairvoyant can make A's solution unboundedly worse than the optimal solution. Therefore, the assumption that A is c-competitive is contradicted.

In a ride-sharing platform where the objective is to maximize the monetary profit, it is important to utilize a pricing model which is fair to both riders and drivers. In another possible pricing model, drivers are compensated based on the distance they travel and this is the total fare all riders have to pay (split). Therefore, for the portions of the trip where there are more than one passenger, the fare gets divided by the number of passengers on the vehicle. It is true that on average, riders end up paying less as compared to when they are the only passenger on the vehicle. However, the problem with this model is that the riders are still paying for the detours incurred in their trip, even though they split the cost. Therefore, if long detours are incurred in a rider's trip, the rider may end up paying even more than when he is the only passenger. For example, with a simple experiment on New York City's taxi dataset, it was observed that up to 10% of riders pay more than what they would have paid if they did not participate in ride-pooling.

A pricing model is defined which aims to satisfy the monetary constraints of the users of the system. It is important to note that one of the building blocks of any real-world ride-sharing system is to compute the shortest path between any two points in the road network. Without loss of generality, the pricing model of the price-aware real-time auction-based ride-sharing system as described herein is discussed based on a static road network where edge weights remain stationary during computation.

However, the algorithms can be extended to incorporate time-dependent networks where cost of edges are time varying. For example, the fare of a ride is dependent on the distance between the pick-up and the drop-off points in a static network where in a time dependent network it can be dependent on the travel time between those two points. A fair pricing model has to satisfy the following rules: (1) For every single rider, if the rider's trip is longer than the shortest trip between his pick-up and drop-off location, the rider should receive a discount proportional to his detour (i.e., the difference between the actual and the shortest trip). (2) For a driver, if the driver's trip is increased by serving more riders, the driver's compensation should increase proportional to the distance of the driver's trip.

Consequently, the pricing model of the price-aware real-time auction-based ride-sharing system answers three key questions: (1) “How much should the riders pay for a trip?” (2) “How much should the drivers be compensated for serving riders?” and (3) “What is the revenue of the ride-sharing platform?”

The pricing model of the price-aware real-time auction-based ride-sharing system is defined by answering these three questions. Every request r has a default fare based on the shortest distance, dᵣ, from sᵣ to eᵣ. In other words, every pricing model should have an arbitrary function F:d→$ such that F(d) is the default fare of a ride. In a ride-sharing system, the actual route between the pick-up and drop-off locations of a ride is not necessarily the shortest route between the two points. The actual route between the two end points of a ride is represented with and the detour of a ride is defined as δdᵣ=dᵣ′−dᵣ. As explained herein, each request is associated with a profile. A rider's profile may be used as a tool for the rider to specify how much discount the rider expects to receive in return for a certain amount of detour on the rider's trip. A rider's profile can have different formats: linear decay or exponential decay, which represents that the rider is not willing to take a service after the decay point.

Subsequently, for a request r with shortest distance dᵣ, detour δdᵣ and a profile fᵣ, the final fare is represented as:

fare(r)=F(dᵣ).fᵣ(Δdᵣ)

This guarantees that no rider pays more than what the rider would have paid if the rider took a solo ride. In fact, the rider will get compensated for longer trips due to the detour. This satisfies the first rule of the fair pricing model.

Each driver has a unique profile which allows the driver to specify the cost of the driver's service. Drivers can have different expectations for participating in ride-sharing platforms. The drivers' profile allows them to set their expectations with respect to how much they expect to be paid for participating in the platform.

Intuitively, the profile is a monotonically increasing function. At any point in time, each driver has a schedule. A driver will be compensated during the time its schedule is not empty. Therefore, for every driver v, the income is:

incomeᵥ=∫ₛₜₐᵣₜ_{ₛ}^{end}^{ₛ}I(Sᵥ(t)≠ [symbol] ).gᵥ(d(t))dt

Where I( ) is the indicator function, Sᵥ(t) and dist(t) are the driver's schedule and the distance the driver travels at time t, respectively. In addition, startₛ and endₛ are the first pick-up time and last drop-off time of Sᵥ. Consequently, regardless of the serviced requests, each driver receives an income only based on the driver's total travel distance.

This satisfies the second rule of the fair pricing model. The amount of a driver's compensation does not necessarily have to be the same as what the riders pay for the same distance. It is the framework's responsibility to assign riders with drivers where their profiles are compatible. The profit the price-aware real-time auction-based ride-sharing system makes from driver v is the difference between the fares collected from all riders serviced by v and the income v receives. Subsequently, the total profit (revenue) of the price-aware real-time auction-based ride-sharing system is the sum of the profits received from all drivers:

profitᵥ=Σᵣ_{ᵢ}_{∈S}_{ᵥ}fare(rᵢ)−incomeᵥ

revenue=Σ_{v∈V}profitᵥ

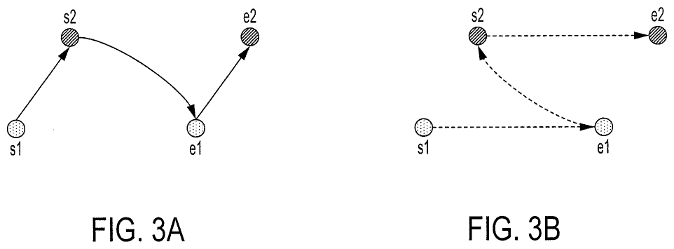

A price-aware framework can utilize pricing models and profiles in order to provide a better service quality. Consider the example in FIGS. 3A and 3B where a driver is en-route to pick-up a rider from sᵢ and drop off at e₁. Before the driver reaches s₁, a new request arrives with s₂ and e₂ as the pick-up and drop-off locations, respectively. It is also assumed that both {s₁, s₂, e₁, e₂} (FIG. 3A) and {s₁, e₁, s₂, e₂} (FIG. 3B) are valid schedules. Any algorithm with the objective of minimizing the total travel distance will select the route in FIG. 3A.

With the price-aware real-time auction-based ride-sharing system, the riders are able to set their profiles such that the framework might end up selecting either of the routes in FIG. 3A or FIG. 3B. For example, if riders want to get to their destination with the least amount of detour, they can set their expected compensation for even small detours to a relatively high value and the framework will select the route in FIG. 3B as the schedule for the driver. On the other hand, if riders are willing to share a ride and reduce the cost of their ride, they can do so by configuring their profiles differently. Depending on what the riders and drivers accept as a higher quality service, by setting their respected profiles they can adjust the price-aware real-time auction-based ride-sharing system to provide them with a service that better suits them. FIGS. 3A and 3B only contemplate a single driver and two riders, and many more complex situations may be possible.

Even though in this example, a shorter detour in FIG. 3B is achieved through avoiding ride-pooling, in experiments it was shown that at least 80-90% of the riders do engage in ride-pooling and yet, end up with a detour of only 6-7% of their original trip.

The pricing model of the price-aware real-time auction-based ride-sharing system is versatile. While the framework as described above is based on the objective of maximizing the provider's revenue, using the same definitions and by configuring the riders' and drivers' profiles differently, the framework can be adjusted to achieve other objectives as well. For example, total travel distance of drivers may be minimized. Other approaches may achieve this goal by assigning a new request to the driver with the least increase in travel distance. Theorem 2 shows, with only configuring the riders' and drivers' profiles appropriately, the price-aware real-time auction-based ride-sharing system can make exactly the same assignments and achieve the same objective.

THEOREM 2: If all the riders' profiles are set to fᵣ′=1 and every drivers' profiles to gᵤ′=1, by selecting the most profitable driver, the price-aware real-time auction-based ride-sharing system will select the driver with the minimum increase in travel distance.

PROOF. Upon arrival of a new request r, each driver in the price-aware real-time auction-based ride-sharing system finds a schedule which generates the most profit. Since f′ᵣ(δdᵣ)=1, regardless of δdᵣ, the final fare for r is equal to F(dᵣ) where dᵣ is the length of the shortest path between r's pick-up and drop-off points. Therefore, for an incoming request r, every driver v can compute the maximum profit it can generate for the system upon accepting r as: profitᵤ=F(dᵣ)−g′(δdᵤ) where deltadᵤ is the increase in v's traveled distance if r is assigned to v. Since F(dᵣ) is the same regardless of the driver, the most profitable driver is the one with the smallest δdᵥ.

In a conventional real-time ride-sharing application, once the server receives a request, it needs to determine the driver who can best accommodate the new request with respect to his current schedule. With a large number of candidate drivers, the scheduling phase becomes the bottleneck in centralized frameworks where there is a single server processing the requests. However, the price-aware real-time auction-based ride-sharing system overcomes this shortcoming by distributing the scheduling task to the drivers themselves.

The price-aware real-time auction-based ride-sharing system uses an auction framework for assignment problems. The price-aware real-time auction-based ride-sharing system considers drivers as bidders and ride requests as goods. The actual human driver does not engage in active bidding. Instead, the driver's mobile app software does the bidding based on various constraints and goals. The server plays the role of a central auctioneer in the price-aware real-time auction-based ride-sharing system. With the price-aware real-time auction-based ride-sharing system, once a new request is received by the server (auctioneer), it presents the request to the drivers (bidders).

Each driver computes a new schedule which incorporates the incoming request, and generates a bid based on the driver's and riders' profile. Subsequently the bid is submitted to the server. The bidding process is performed as a sealed-bid auction where drivers simultaneously submit bids and no other driver knows how much the other drivers have bid. In the end, the server selects the driver with the highest bid as the winner and matches the request with the driver.

With the price-aware real-time auction-based ride-sharing system, drivers who are far away from the pick-up location of an incoming request are not asked to bid on the request. The server only sends an incoming request to available drivers who are defined as eligible drivers. An available driver v is said to be eligible for servicing a newly submitted request r, if and only if distance(v, r.s)≤r.w×avg_speed. In other words, an available driver d is eligible for serving request r, if the driver has enough time to reach the pick-up location of r within r's waiting time. In order to find eligible workers for each request, the server maintains a spatial index on the location of the drivers.

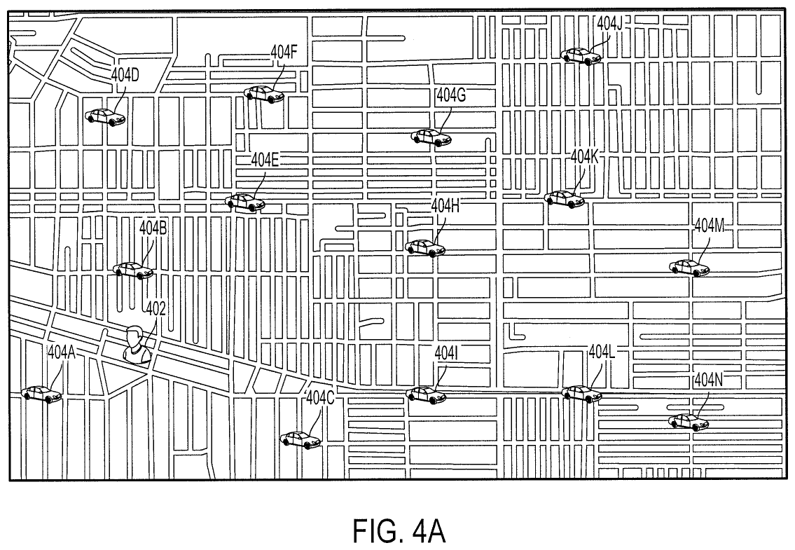

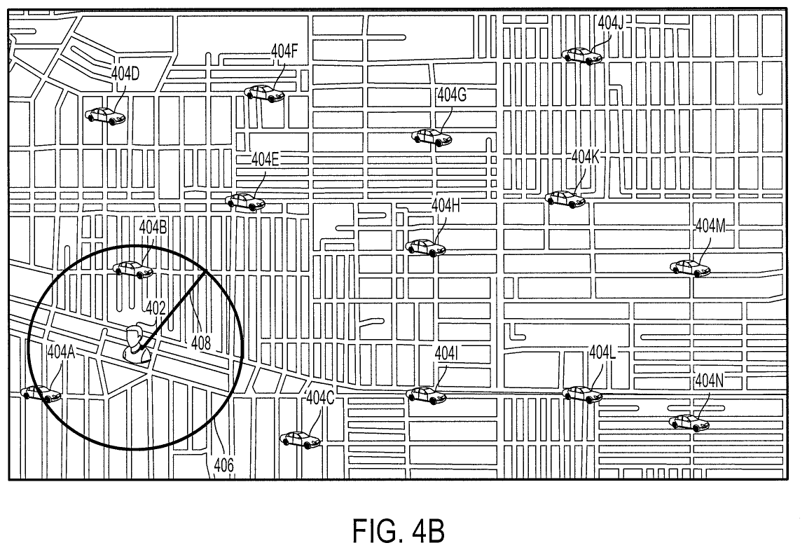

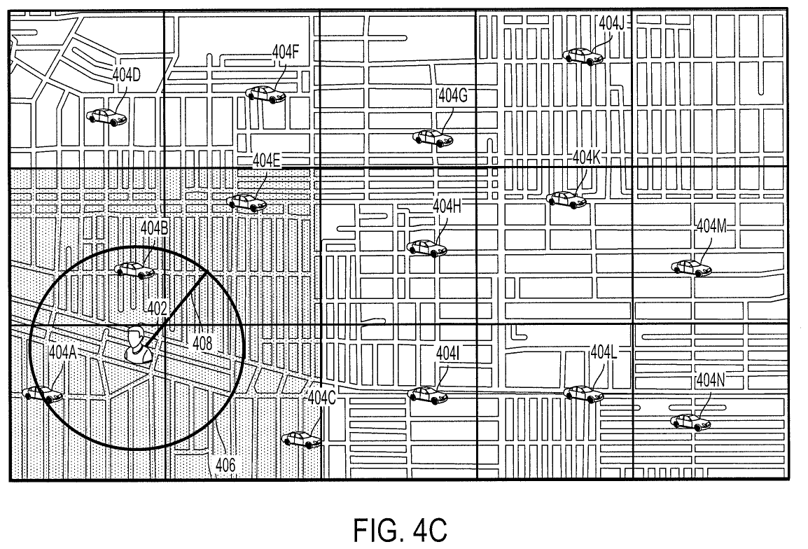

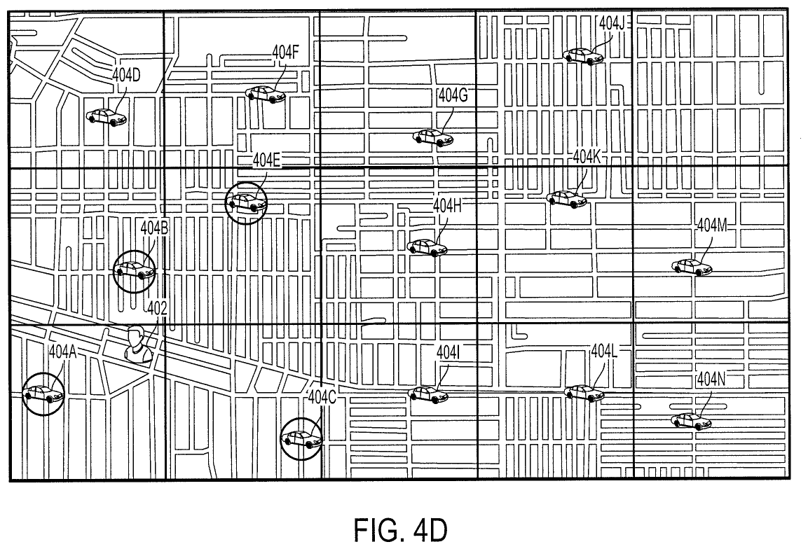

FIG. 4A illustrates a rider 402 and a plurality of drivers 404. The rider 402 uses a rider mobile device (e.g., rider mobile device 102) and sends a ride request to a server (e.g., server 104). The rider 402 has a range 406 defining an area within a radius 408 of the rider 402. The radius 408 corresponds to the maximum wait time r in the formula above. With the price-aware real-time auction-based ride-sharing system, the server does not need to know the exact location of the drivers 404 to be able to filter out non-eligible drivers. As illustrated in FIG. 4C, a grid index may be used, where the server only keeps track of which cell a driver 404 is located in. As shown in FIG. 4C, any driver 404 in the shaded cells will receive the new request. As shown in FIG. 4D, in particular, those drivers are drivers 404A, 404B, 404C, and 404E. In the grid index, a filter and refine process is used in order to enable continuous query processing on the underlying road network using Euclidean distances.

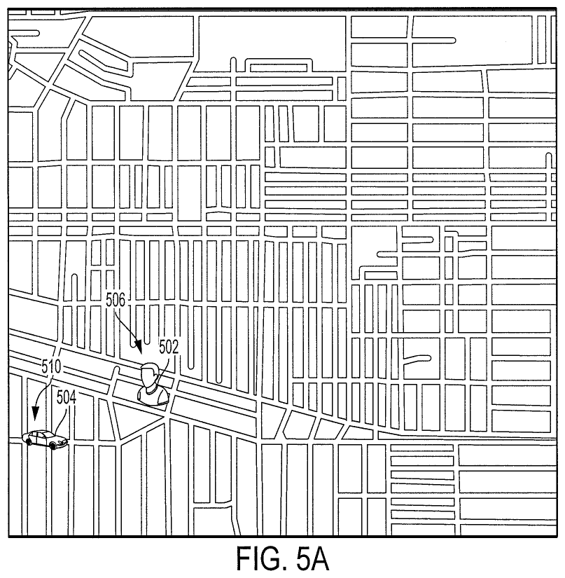

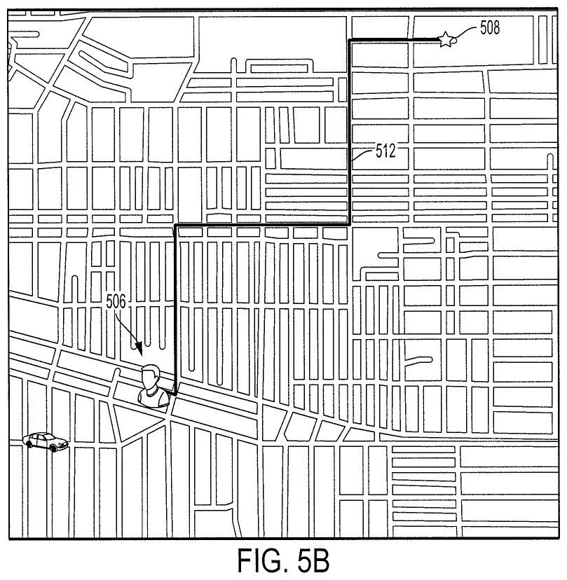

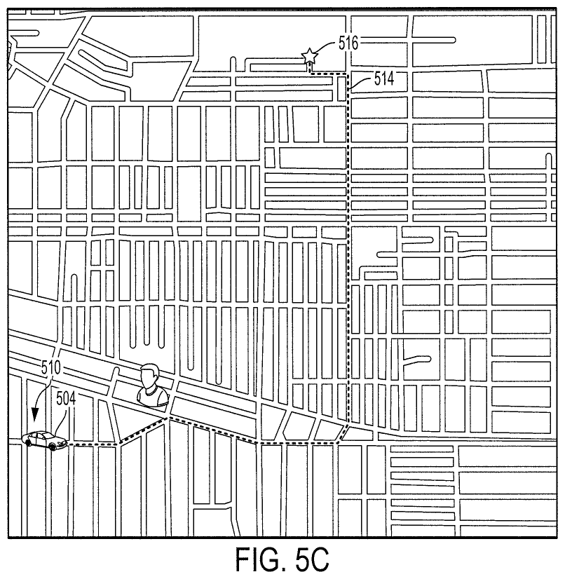

The process of the driver mobile device determining a bid is illustrated in FIGS. 5A-5D. The potential rider 502 has a rider location 506, and the driver 504 has a current driver location 510, as shown in FIG. 5A. The potential rider 502 would like to go from the rider location 506 to the rider destination 508, as shown in FIG. 5B. A route 512 from the rider location 506 to the rider destination 508 is determined, and a base fare corresponding to that route 512 is determined. The driver 504 is at a current driver location 510 with a passenger (or existing rider, first rider, or current rider) who needs to go to passenger destination 516 at the end of the current route 514, as illustrated in FIG. 5C. The profit associated with current route 514 is determined. An updated route 518 is determined based on the rider location 506 and the rider destination 508, as shown in FIG. 5D. The updated route 518 is different than the current route 514, as the rider 502 is not perfectly along the current route 514. Accordingly, there is an increased distance associated with picking up the potential rider 502 at rider location 506. The profit associated with the updated route 518 is determined, and the difference between the profit associated with the updated route 518 and the profit associated with the current route 514 is the bid amount. As described herein, the profit for any route for this particular driver 504 is based on the driver profile of driver 504 and the rider profile of the passenger.

Algorithm 1 outlines the process of assigning an incoming request r, according to some embodiments. Vᵣ is the set of eligible drivers for request r (line 3). All the iterations of the for loop in Algorithm 1 (lines 3-6) run in parallel. The ComputeBid( ) method (line 4) that each driver executes, performs scheduling and computes the highest profit v can generate for the platform. In case of a tie in line 7, the algorithm randomly selects one driver among the ones with the highest bid. The server 104 is programmed to execute lines 1-2 and lines 7-8 of Algorithm 1; and each driver mobile device is programmed to execute lines 3-6 of Algorithm 1 and communicate their respective results to the server 104.

Algorithm 1: Dispatch(V; r; time)

```
            Input: V is the set of currently available drivers, r is a new
request and time is the current time.
            Output: v ϵ V as the driver which request r should be
            assigned to.
            1: v_{selected} = null
            2: Bids = ∅
            3: for v ϵ Vᵣ do
            4: bᵥ =ComputeBid(v, r, time)
            5: Bids ← bᵥ
            6: end for
            7: v_{selected} = arg maxₓ {bₓ ϵ Bids}
            8: return v_{selected}
```

Once a driver mobile device is notified of a new request, it computes a bid. The bid each driver mobile device generates reflects the profit the system can gain if the request is assigned to the driver associated with the driver mobile device. The generated bid is submitted to the server 104. Once a new request is assigned to a driver, the driver will be notified with an updated schedule. The process is automated so that the human driver's interaction with the price-aware real-time auction-based ride-sharing system is limited to configuring the driver's profile on the ride-sharing application.

Algorithm 2 outlines the bid computation process, according to some embodiments. Algorithm 2 is performed by each driver mobile device in response to receiving a ride request from the server 104. First, the pick-up locations (including the new request's pick-up point) are inserted in the list named src (lines 1-2). Then, the algorithm calls FindBestSchedule which finds the best valid schedule and its corresponding profit using Algorithm 3. Because each driver's bid is the additional profit that the new request can generate for the platform, profit(old) may be calculated using Algorithm 4 for v's original schedule (line 4). Hence, the additional profit that v can generate by accepting r is the difference between profit_{new} and profit_{old}.

Algorithm 2: ComputeBid(v, r, time)

Input: v is a driver, r is a new request and time is the current time.
Output: additional profit that v can generate by accepting r
1: src = {r′ .s|r′ ϵ v.schedule}
2: src.add(r.s)
3: profit_{new}, schedule = v.FindBestSchedule(∅, src, −∞, ∅, time)
4: profit_{old} =GetProfit(v.schedule, time)
5: return profit_{new} − profit_{old}

Algorithm 3 outlines the determination of the most profitable schedule. Each driver mobile device is programmed to perform Algorithm 3. The reason FindBestSchedule is initially called with only the pickup locations is to guarantee, for every request its pick-up location is scheduled before its drop-off location. Every valid schedule is enumerated, the profit for each valid schedule is calculated, and the most profitable schedule is chosen. Therefore, the algorithm recursively performs an exhaustive search to find the best valid schedule. Given the set of nodes that have already been added to the schedule (i.e., set f), and the remaining nodes (i.e., set r), at each iteration of Algorithm 3 (lines 4-23), one node from r is added to f (lines 5-6). Each time a new node is added to f, the algorithm checks whether this partial schedule is valid. If the partial schedule is invalid, GetProfit in line 7 returns −∞ and the search continues to the next branch. Otherwise, the variable p contains the profit of the partial schedule f Once the pick-up node of a request is added to f, the drop-off node of the same request is added to r (line 11-12). If the remaining nodes get empty, the search on the current branch stops and the current branch's profit p is returned (lines 14-15); otherwise, it recursively checks the new branch r′ (line 17). The best profit is updated once the search finds a profit p higher than the best profit seen so far bp (lines 18-20).

Algorithm 3: FindBestSchedule(f, r, bp, bs, start)

Input: f and r are lists of pick-up/drop-off points that have

been added and to be added to a valid schedule, respectively. bp and bs
are the best profit and corresponding schedule observed so far and start
is the current time.

```
Output: bp, bs as the best profit and corresponding schedule
for input points if a valid schedule exists. Otherwise −∞, Ø
  1:  if f.size +r.size > v.n ×2 then
  2:  return bp, bs
  3:  end if
  4:  for p in r do
  5:  f′ = f
  6:  f′ .add(p)
  7:  p = GetProfit(this, f′, start)
  8:  if p ≠ −∞ then
  9:  r′ = r
10:  r′.remove(p)
11:  if p.type = start then
12:  r′.add(p.req.end)
13:  end if
14:  if r′.size = 0 then
15:  return p, f′
16:  end if
17:  p, s = FindBestSchedule(f′, r′, bp, bs, start)
18:  if p > bp then
19:  bs = s
20:  bp = p
21:  end if
22:  end if
23:  end for
24:  return bp, bs
```

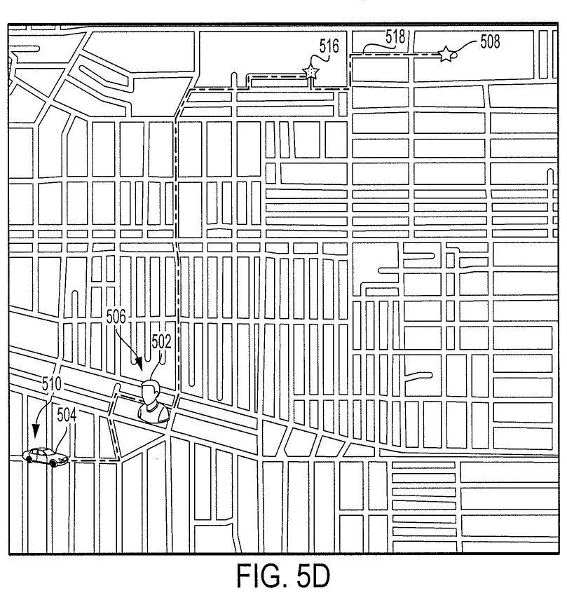

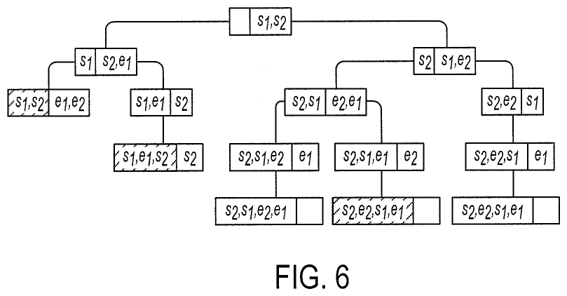

FIG. 6 illustrates an example of using Algorithm 3 to find a best schedule with two requests r₁ and r₂. Each rectangle represents a node in the search tree, where the left and right sections contain the scheduled points and the remaining points, respectively (sets f and r in Algorithm 3). Initially, the set r is started with the two pick-up locations. Each time a new pick-up point (e.g., s₁) is scheduled and moved from the right section to the left, the corresponding dropoff point (e.g., e₁) will be added to the right section. The shaded rectangles contain an invalid partial schedule in the left section and hence, the tree does not expand under them. The search continues until all the branches have been visited and the complete schedule with the highest profit is returned.

Algorithm 4 computes the profit driver v can generate by completing schedule at time start. Each driver mobile device is programmed to perform Algorithm 4. Each driver v runs this algorithm locally, and hence, u.loc (line 2) and u.g( ) (line 20) refer to v's current location and profile, respectively. Also, for any node p in the schedule, p.req and p.req.sp refer to the corresponding request of node p and the shortest path for that request, respectively. Algorithm 4 iterates through the nodes in schedule one by one keeping track of the added time and distance. Each node is either a pick-up node or a drop-off node. For pick-up nodes, the algorithm checks if the maximum wait time constraint is violated (line 9). For every drop-off node, the detour constraint is checked (line 16). If the check is successful, the algorithm computes the actual travel distance for the request and determines the incurred detour (line 19). After computing the detour, the algorithm computes the added fare and cost. If the input schedule is not valid, the algorithm returns −∞ as the profit. Once drivers submit their bids, the server selects the driver with the highest bid as the winner and assigns the new request to that driver.

Algorithm 4: GetProfit(v, schedule, start)

Input: schedule is an ordered list of pick-up/drop-off

points of driver v and start is the current time.

Output: the profit of performing the input schedule at

time start. If schedule is not valid it returns −∞.

```
  1:  time = start
  2:  loc = v.loc
  3:  distance = 0
  4:  for p in schedule do
  5:  trip = ShortestPath(loc, p.loc)
  6:  distance += Distance(trip)
  7:  time += TravelTime(path)
  8:  if p.type = start then
  9:  if time > p.req.req_time +p.req.w then
10:  return −∞
11:  end if
12:  pickUp[p.req] = distance
13:  end if
14:  if p.type = end then
15:  δd = distance − pickUp[p.req]
16:  if δd > p.req.ϵ × p.req.sp then
17:  return −∞
18:  end if
19:  fare += p.f(δd) × F(p.req.sp)
20:  cost = v.g(distance)
21:  end if
22:  end for
23:  profit = fare − cost
24:  return profit
```

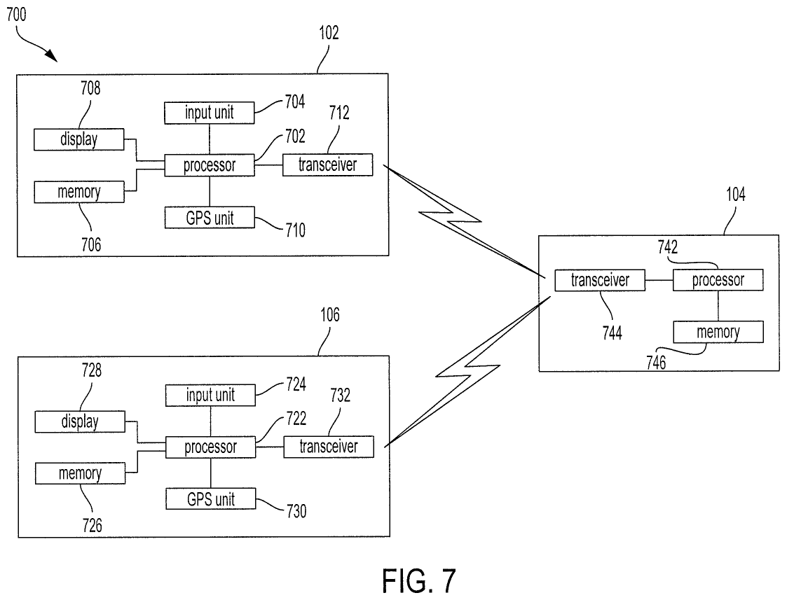

FIG. 7 illustrates the price-aware real-time auction-based ride-sharing system according to various embodiments. The system 700 includes a rider mobile device 102, a driver mobile device 106, and a server 104, as described herein.

The rider mobile device 102 (or client device associated with the rider) includes a processor 702 connected to an input unit 704, a memory 706, a display 708, a GPS unit 710, and a transceiver 712. In some embodiments, the rider mobile device 102 and the driver mobile device 106 are each embodied by smartphones. In some embodiments, the rider mobile device 102 is a smartphone and the driver mobile device 106 is integrated into the driver's vehicle.

In some embodiments, the driver is a human driver. In other embodiments, the driver is a vehicle electronic control unit configured to operate the vehicle autonomously. In these embodiments where the vehicle is an autonomous vehicle, the driver profile may be that of the owner of the vehicle or an operator of the vehicle. For example, the vehicle may be owned by a ride-sharing service provider, and the expected profit from operating the autonomous vehicle within the price-aware real-time auction-based ride-sharing system may be based on the costs of operating the autonomous vehicle and the overall business plan of the ride-sharing service provider. When the driver is a human driver, the driver profile may be based on the personal needs of the driver, monetary or otherwise.

The input unit 704 is configured to receive an input from the rider. The input unit 704 may be a keyboard, a touchscreen, a microphone, a camera, or any other device capable of receiving input. The rider may define the rider profile using the input unit 704. The rider may also input the maximum wait time and the desired destination using the input unit 704.

The memory 706 may be configured to store various data described herein, such as the rider profile and the maximum wait time of the rider.

The display 708 may be configured to display information to the rider, such as a map of where the rider is in relation to drivers, or the rider profile.

The GPS unit 710 may be configured to receive GPS data and determine the location of the rider. The GPS unit 710 may provide the location of the rider to the processor 702 in terms of geographical coordinates, such as latitude and longitude.

The transceiver 712 may be configured to communicate with the server 104 by transmitting and receiving data. The transceiver 712 may communicate with the server 104 over a distributed data communication network using a communications protocol.

The driver mobile device 106 (or a client device associated with the driver) includes a processor 722 connected to an input unit 724, a memory 726, a display 728, a GPS unit 730, and a transceiver 732.

The input unit 724 is configured to receive an input from the driver. The input unit 724 may be a keyboard, a touchscreen, a microphone, a camera, or any other device capable of receiving input. The driver may specify the driver profile using the input unit 724.

The memory 726 may be configured to store various data described herein, such as the driver profile, the capacity of the vehicle, and the number of passengers currently in the vehicle and their respective rider profiles.

The display 728 may be configured to display information to the driver, such as the driver profile, or a map of where the driver is in relation to a current destination or a potential destination, other drivers, or riders.

The GPS unit 730 may be configured to receive GPS data and determine the location of the driver. The GPS unit 730 may provide the location of the driver to the processor 722 in terms of geographical coordinates, such as latitude and longitude.

The transceiver 732 may be configured to communicate with the server 104 by transmitting and receiving data. The transceiver 732 may communicate with the server 104 over a distributed data communication network using a communications protocol.

The server 104 includes a processor 742 connected to a transceiver 744 and a memory 746. The transceiver 744 may be configured to communicate with the rider mobile device 102 and/or the driver mobile device 106 by transmitting and receiving data. The transceiver 744 may communicate with the rider mobile device 102 and/or the driver mobile device 106 over a distributed data communication network using a communications protocol. The memory 746 may be configured to store various data described herein, such as the bids received by the drivers and the ride requests received from the rider.

While only one rider mobile device 102 and one driver mobile device 106 is illustrated in FIG. 7, there may be any number of rider mobile devices and driver mobile devices communicating with the server 104. As described herein, the price-aware real-time auction-based ride-sharing system 700 is scalable, so the server 104 is able to handle an increase in the number of rider mobile devices and driver mobile devices.

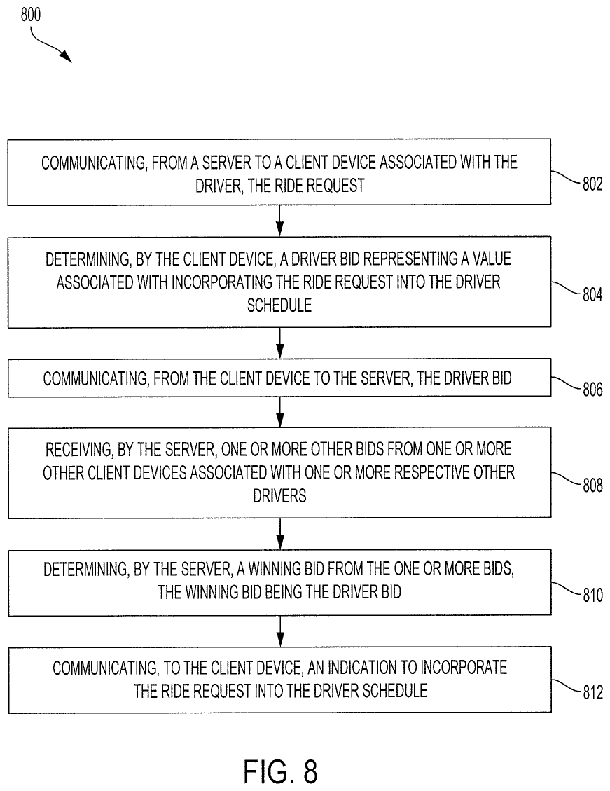

FIG. 8 illustrates a process 800 of the price-aware real-time auction-based ride-sharing system, according to embodiments of the invention.

The server 104 receives, from a rider mobile device 102, a ride request including a rider location, a rider destination, and a rider wait time. The ride request may be transmitted by the transceiver 712 of the rider mobile device 102 and received by a transceiver 744 of the server 104.

The server 104 communicates, to a driver mobile device 106, the ride request (step 802). The ride request may be transmitted by the transceiver 744 of the server 104 and received by a transceiver 732 of the driver mobile device 106.

The driver mobile device 106 determines a driver bid representing a value associated with incorporating the ride request into the driver schedule (step 804). The processor 722 of the driver mobile device 106 may determine the driver bid. The driver bid determination may be based on, among other things, the location of the driver as determined by the GPS unit 730 of the driver mobile device 106, and the capacity of the vehicle, the current destination of the current passenger, the rider profile of the current passenger, the driver profile, all stored in the memory 726. As described herein, the driver bid is determined based on a comparison of a current profit without including the ride request in the driver's schedule and an expected profit from including the ride request in the driver's schedule.

The driver mobile device 106 communicates the driver bid to the server 104 (step 804). The driver bid may be communicated via the transceiver 732 of the driver mobile device 106 and the transceiver 744 of the server 104. The server 104 receives, from one or more other driver mobile devices, one or more other driver bids (step 806). As described herein, the one or more other driver mobile devices may be associated with drivers who are in proximity to the location of the rider who submitted the ride request.

The server 104 determines the winning bid from the one or more bids, the winning bid being the driver bid (step 810). In some embodiments, the winning bid is the bid resulting in the greatest profit. The processor 742 of the server 104 may perform this step by comparing the driver bids received from the multiple drivers.

The server 104 communicates, to the driver mobile device 106, an indication to incorporate the ride request into the driver's schedule (step 812). The indication may be communicated via the transceiver 744 of the server 104 and the transceiver 732 of the driver mobile device 106.

Extensive experiments were conducted on a large scale New York City taxi dataset and the experiments show that the price-aware real-time auction-based ride-sharing system is scalable and efficient, capable of processing hundreds of tasks per second in the presence of thousands of drivers. By comparing the framework of the price-aware real-time auction-based ride-sharing system with the state of the-art approaches, it is shown that the framework of the price-aware real-time auction-based ride-sharing system can simultaneously match up to 10% more riders to drivers (i.e. higher service rate), while the total travel distance of riders are 20% less (i.e., better service quality). As a result, the framework of the price-aware real-time auction-based ride-sharing system can generate more profit than other approaches with an even better service quality. In contrast, it is shown that in a framework where riders are assigned to drivers with the least increase in the driver's travel distance, up to 25% of the requests are not assigned to the most profitable driver.

The algorithms described herein were evaluated using one month (May 2013) of New York City's taxi dataset, which contains 39,437 drivers and around 500,000 trips per day. Each ride in the dataset has a pick-up latitude/longitude, a drop-off latitude/longitude and request time. The road network of New York City was extracted from Open Street Map (OSM), which is represented as an undirected graph with 55,957 vertices and 78,597 edges. Subsequently, the source and destination of each trip was mapped to the road network. A cache was maintained for shortest paths between vertices, such that the shortest path can be found in constant time.

Initially, each driver was randomly located on one vertex of the road network. When the vehicle is serving rider requests, it was assumed it was following the schedule and moving constantly towards the destination.

The results of the framework of the price-aware real-time auction-based ride-sharing system (labeled “APART”) were compared with two other approaches: TREE (i.e., Kinetic tree) from academia and NN (i.e., Nearest Neighbor) from industry.

Since TREE does not provide any pricing model, once a ride is completed, its incurred detour was computed and Equations (1) to (3) were used to compute the platform's revenue. Also, to make the comparison fair, before assigning a request to a driver profile matching was performed to insure the provider does not end up losing money. If the profiles were not compatible, the next driver with the shortest increase in travel distance was selected.

The NN algorithm is implemented based on the current approach adopted by major ride-sharing platforms. To the best of knowledge, these platforms find the first nearest driver to the pick-up location of a new request. If the driver is able to fit the new request in the driver's schedule without violating any constraints, the driver accepts the request. Otherwise, the request is rejected and the algorithm tries to assign the request to the next nearest driver. This continues until a driver accepts the request, or every driver rejects it, in which case the request is dropped.

In the first set of experiments, the pricing model described herein was used and compared across the three approaches. In later experiments, a pricing model proposed in “Real-time city-scale taxi ridesharing,” IEEE Transactions on Knowledge and Data Engineering, vol. 27, no. 7, pp. 1782-1795, 2015 (hereinafter “Real-time”) is utilized for both APART and TREE. Because there is no concept of revenue in this pricing model, in order to compare the generated revenue, it is assumed that each driver has to pay 20% of their income as the platform's share.

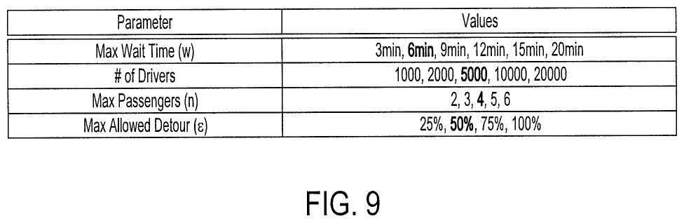

In the experiments, the following three metrics were measured by varying different parameters of the system: (1) service rate as the percentage of requests that were completed, (2) the revenue of the system and (3) the response time for matching a request with a driver. FIG. 9 shows the different values used for various parameters to evaluate the framework (default values are shown in bold).

For the pricing model by default it is configured as:

F(d)=2×d

∀r,fᵣ(δdᵣ)=1−(0.25×δdᵣ²)

∀u,gᵤ(d)=1.5×d

The performance of the three approaches was compared and analyzed using the default parameters in FIG. 9 with respect to service rate, generated revenue and response time.

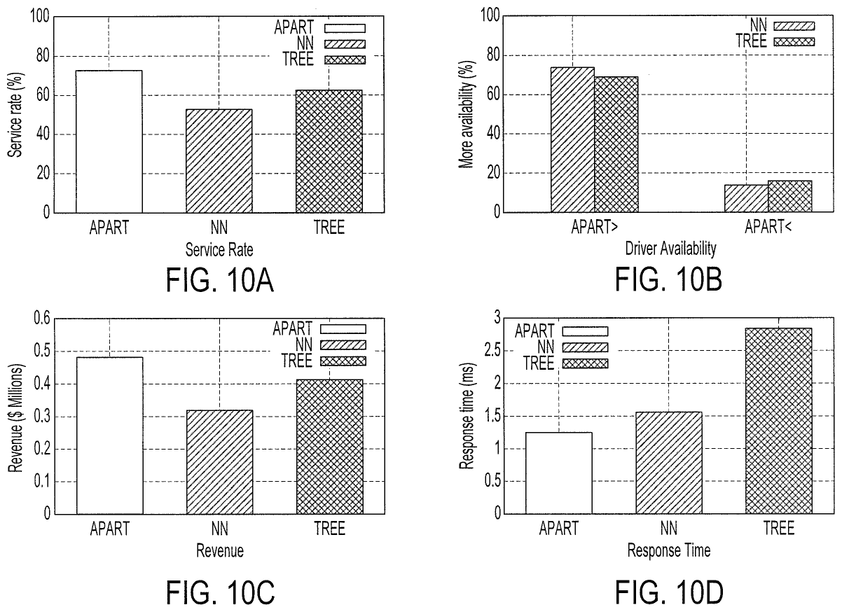

As shown in FIG. 10A, APART is able to serve more requests (i.e. higher service rate) compared to the other two approaches. For all three approaches, the same set of requests and drivers for each iteration is used. This means all approaches start with the same configuration in the road network. However, each approach assigns riders to drivers differently and hence, after a while the dynamism of the network (i.e., location of the drivers on the road network) will be different in each algorithms. To understand the reason for higher service rate, for each incoming request, the number of eligible workers is also counted. The driver availability in algorithm A is higher than B with regard to request r, if during the simulation, more eligible drivers in algorithm A are available for r compared to that of algorithm B.

FIG. 10B shows the percentage of the requests for which APART has higher (lower) driver availability compared to the other two approaches. The left two bars in FIG. 10B show that for more than 60% of the requests, APART has a higher driver availability compared to both NN and TREE. This means that APART engages drivers more effectively compared to NN and TREE and hence, is able to serve more requests.

Next, the algorithms are compared with regard to how much revenue they generate. FIG. 10C shows APART which generates almost 20% and 50% more revenue compared to TREE and NN, respectively.

As noted herein, the driver with minimum increase in travel distance is not necessarily the most profitable driver. To verify this theory, when running TREE, for each incoming request (and after the algorithm chose the driver with least increase in traveled distance), all eligible drivers were checked to see which one generates the highest profit by serving the new request. A similar check was also performed when running NN. Based on the results, for 23% of the requests, the driver chosen by TREE is different from the most profitable driver. This number for NN is 70%. With implementation of TREE and NN, the request is not assigned to a driver that cannot satisfy the monetary constraint. In other words, both approaches make sure by assigning a request to a driver, the platform provider does not lose money. If this check is relaxed for both approaches, in TREE, 5% of the requests are assigned to drivers that lose money. This number is 40% for NN.

The final metric for comparison is the average response time for processing a single request. As shown in FIG. 10D, with the default setting, the processing time in TREE is almost twice the response time in APART. The reason is that although TREE utilizes a “Kinetic Tree” data structure which maintains the current available schedules to expedite the scheduling process, the server has to perform scheduling for eligible drivers sequentially while the auction based approach in APART, distributes the scheduling to the drivers.

Nevertheless, with the default settings, all three approaches process the requests under 3 ms, which is acceptable for a real-time framework. Different parameters are varied based on FIG. 9 and the effect of each parameter on the same metrics is evaluated.

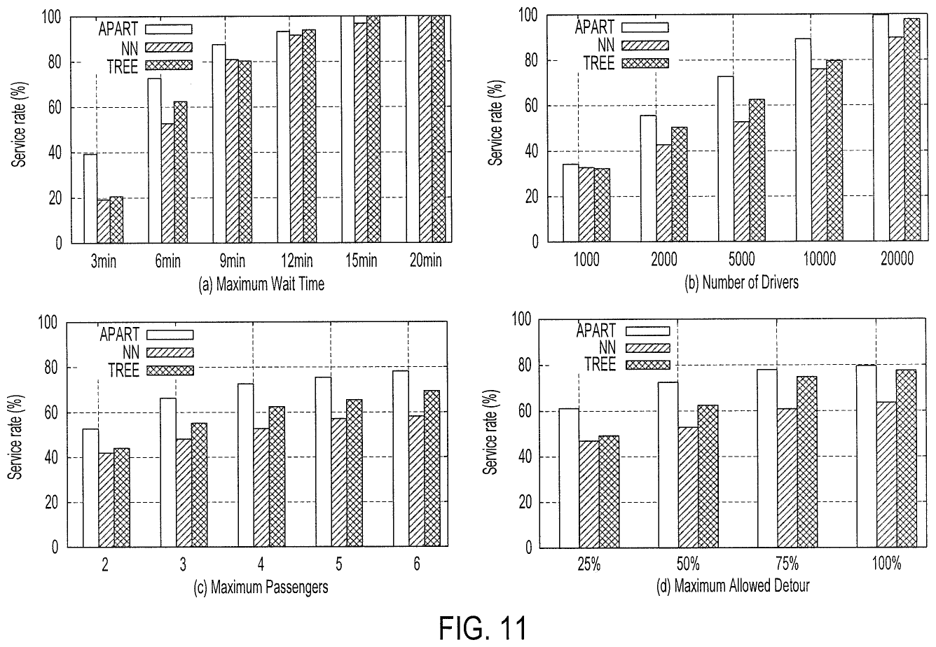

In this set of experiments, the service rate of the three approaches is compared. As shown in FIG. 11, all algorithms generate high service rates when the constraints are relaxed or there is high resource availability. However, under tight constraints or limited resources, APART outperforms the other two approaches by up to 20%. It was shown above how APART copes with the dynamism in the system better than the other two approaches.

As mentioned, the main objective of APART is to maximize the ride-sharing platform's revenue. In this experiment, the generated revenue of each algorithm is compared. The effect of varying the parameters in FIG. 9 on the revenue is evaluated and the different algorithms are compared. Different pricing models are applied to the algorithms and the revenue under different pricing models is compared.

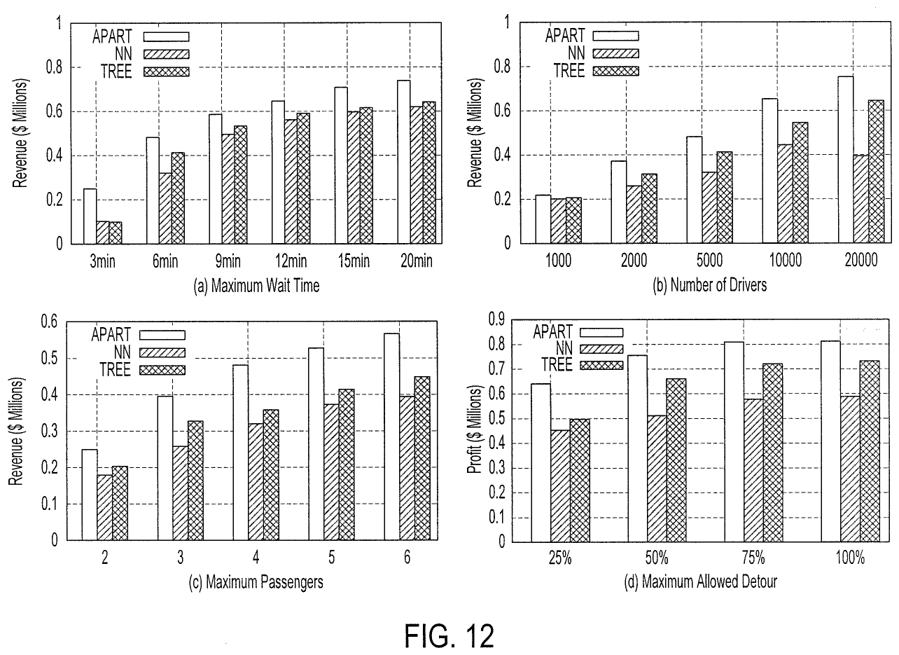

FIG. 12 shows that regardless of the values of different parameters, APART generates more revenue than any other approaches. When the results in FIG. 12 are compared with FIG. 11, even under configurations where all algorithms have the same service rate, APART manages to generate at least 10% more revenue. The main reason for higher revenue is that APART is designed to make a price-aware assignment, i.e., assign the request to a driver that generates the most profit. On the other hand, the TREE and NN algorithms were not designed to maximize revenue. As explained herein, the pricing models that are used in APART are designed such that the higher profits are not gained by scamming the riders.

APART instantly processes a request once it is submitted. In order to evaluate the scalability of the framework, the next set of experiments evaluate the response time of processing a single request.

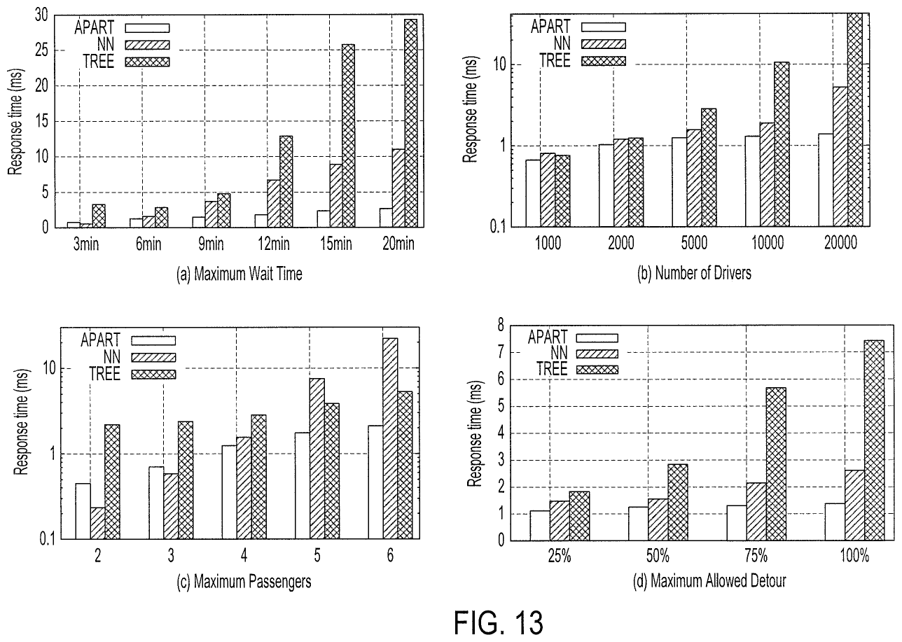

FIG. 13B shows that when more drivers are added, the scalability of TREE suffers, as it has to perform scheduling for a larger number of vehicles. On the other hand, due to the distributed nature of APART's auction-based approach, each driver does scheduling for itself and adding drivers does not affect the overall response time of APART as much. In FIG. 13C, it is observed that although APART's response time does not go beyond 5 ms, TREE handles the increase in maximum passengers better due to the Kinetic Tree structure implementation. The reason for NN's poor performance is that it has to perform scheduling computation sequentially, for possibly multiple drivers. Finally, in FIG. 13A and FIG. 13D it is concluded that for relaxed constraints, the response time of TREE increases up to 4 times higher than that of APART. The main reason is that the Kinetic Tree structure keeps track of all valid orders of requests that are assigned to a driver. As the constraints are relaxed, the number of feasible permutations of the requests increases, which makes the size of the Kinetic Tree larger and updates become more expensive. This, in turn, increases the response time. FIG. 13 shows that unlike the other two approaches, APART's scalability does not suffer by varying different parameters of the framework.

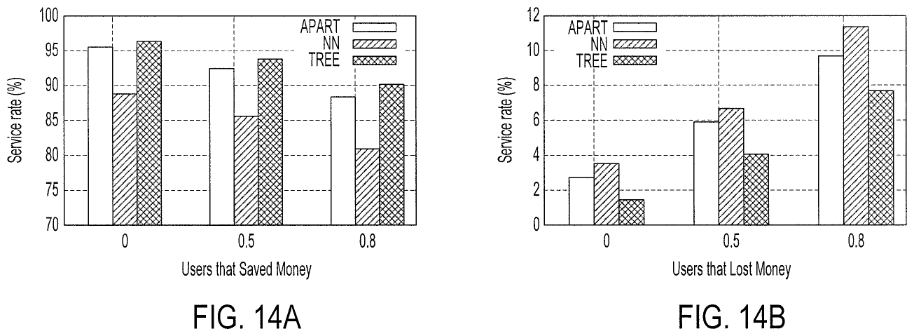

The effect of the pricing model is evaluated. First, the importance of designing a fair pricing model is shown. The three approaches are utilized with the model in “T-share: A large-scale dynamic taxi ridesharing service,” S. Ma, Y. Zheng, and O. Wolfson, Data Engineering (ICDE), 2013 IEEE 29th International Conference on. IEEE, 2013, pp. 410-421 (hereinafter “T-Share”) and it is shown how some riders may suffer by participating in ride-sharing. Subsequently, experiments were performed utilizing the pricing model in “Real-time,” and show that as a result of price-aware assignments, regardless of the model, APART generates more revenue for the platform provider. Finally, the flexibility that profiles provide for the users is shown. FIG. 14 shows the result of utilizing the pricing model in T-Share. Based on this pricing model, the driver's income is c.d₁(1+α).c.d₂ where d₁ is the distance the driver had only one rider on-board, d₂ is the total distance the driver had more than one rider on-board and c is some predefined constant. α takes a value between 0 and 1 which determines the increase in the driver's income for serving more than one rider. As shown in FIG. 14A, by participating in ride-sharing, the majority of riders save money (pay less as compared to riding alone). FIG. 14A supports the claim that, on average, riders will save money. However, FIG. 14B shows that regardless of what algorithm is used, up to 10% of riders pay more by participating in ride-sharing, which is not acceptable. The reason is that, riders have to pay even for detours. Even though riders split the fare on detours, if detours are sufficiently long, even ride-pooling riders lose money.

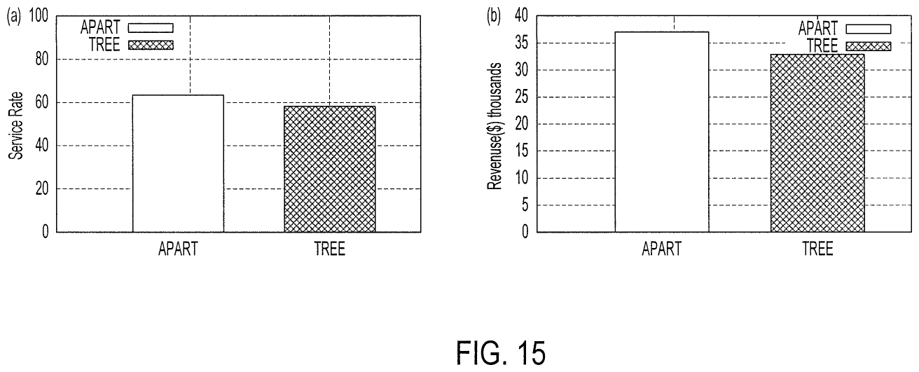

In the next set of experiments, the model in “Real-time” was applied and the performance of APART and TREE was evaluated. In this model, riders were compensated for any detour incurred in their trip. The amount of compensation was based on the new rider's fare and the length of a rider's detour compared with the detour of other riders on the vehicle. Because the algorithm in “Real-time” is similar to TREE, only APART and TREE were compared. FIG. 15A shows that APART provides a slightly higher service rate than TREE. However, due to assigning the riders to the most profitable drivers, APART ends up generating 10% more revenue.

It is mentioned herein that by setting their profiles, users can configure APART to make assignments the way they find desirable. In the last set of the experiments, two different configurations were used to represent the riders' profiles. First, the riders' profiles were set to

$${f}_{T} ( δ {d}_{r} ) = \frac{1}{( δ {d}_{r} + 1 )} .$$

Such a profile is suitable for a rider who wants to minimize the rider's detour and is willing to share a ride only if the detour is short. Since the rider sets tight constraints, this profile is shown by fᵣ. In the second iteration, the profile of the riders was set to

$${f}_{R} ( δ {d}_{r} ) = 1 - ( \frac{δ {d}_{r}}{max δ} ) .$$

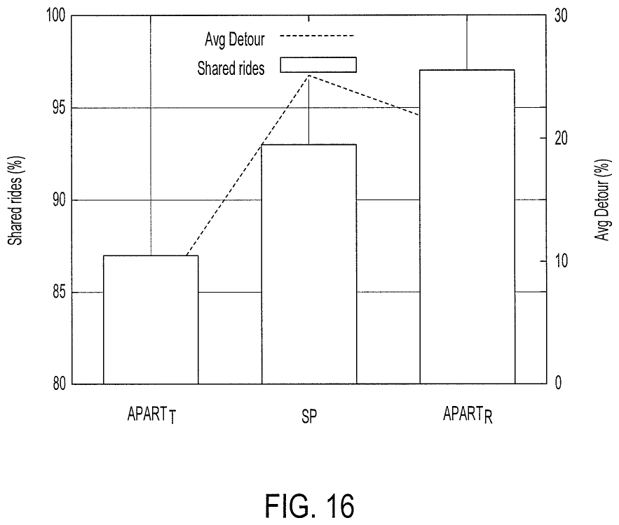

This profile is more Relaxed (hence, f_{R}) and it is expected that more riders share a trip. FIG. 16 shows the result of utilizing APART and TREE with f_{T} and f_{R}. Since TREE does not make price-aware assignments, the results in both iterations were the same. However, as observed with APART_T, almost 10% fewer riders ended up sharing a ride while on average they only observed 6-7% increase in their trips. On the other hand, with APART_R, almost every rider shares a ride and the average increase in their trip was almost 20%. An interesting observation in FIG. 16 is that with APART_R, more riders share a ride compared to TREE while their average detour was still less.

In conclusion, the price-aware real-time auction-based ride-sharing system (APART) is agnostic of the price model and is able to generate more profit. In addition, APART supports different types of riders' expectations by adjusting the profiles.

The price-aware real-time auction-based ride-sharing system disclosed herein provides a general and versatile pricing model and an objective of the price-aware real-time auction-based ride-sharing system is to maximize the total profit of the platform provider. It is shown that by maximizing the overall profit, the framework of the price-aware real-time auction-based ride-sharing system achieves higher service rate and quality. The decentralized auction-based framework of the price-aware real-time auction-based ride-sharing system is able to support scalable and real-time scheduling, which differs from existing centralized scheduling frameworks.

In some embodiments, the road network may be a time-dependent road network, where pre-computing the shortest paths between different nodes of the road network is very difficult, if not impossible. In these embodiments, the shortest paths between different nodes of the road network may be computed in real-time. In other embodiments, the requests arriving within a short period of time (e.g., 5 seconds) may be batched together.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A method for matching a driver associated with a driver schedule and a rider associated with a ride request including a rider location and a rider destination, the method comprising:
communicating, from a server to a client device associated with the driver, the ride request;
determining, by the client device, a driver bid representing a value associated with incorporating the ride request into the driver schedule;
communicating, from the client device to the server, the driver bid;
receiving, by the server, one or more other bids from one or more other client devices associated with one or more respective other drivers;
determining, by the server, a winning bid from the one or more bids, the winning bid being the driver bid; and
communicating, to the client device, an indication to incorporate the ride request into the driver schedule.

2. The method of claim 1, further comprising, communicating, from the server to the one or more other client devices associated with the one or more respective other drivers, the ride request, wherein the one or more other drivers are all located within a range of the rider location.

3. The method of claim 2, wherein the range of the rider location is determined by the server based on a rider waiting time associated with the rider.

4. The method of claim 1, wherein the value is a profit,
wherein the determining the driver bid includes determining the driver bid based on a pricing model for optimizing profit, and
wherein the winning bid is a bid associated with highest profit.

5. The method of claim 1, wherein the value is a travel distance,
wherein the determining the driver bid includes determining the driver bid based on a pricing model for minimizing travel distance, and
wherein the winning bid is a bid associated with a shortest travel distance.

6. The method of claim 5, wherein the driver schedule includes an existing passenger destination associated with an existing passenger, the existing passenger having an existing passenger preference indicating an expected discount rate based on a detour length associated with incorporating the ride request into the driver schedule, and
wherein the driver bid is based on the existing passenger preference.

7. The method of claim 6, wherein the determining the driver bid based on the pricing model for optimizing profit comprises:
determining the detour length associated with incorporating the ride request into the driver schedule;
determining a cost of incorporating the ride request into the driver schedule based on the existing passenger preference;
determining an additional fare from incorporating the ride request into the driver schedule; and
determining a difference between the additional fare and the cost of incorporating the ride request into the driver schedule.

8. The method of claim 1, wherein the driver is associated with a driver preference indicating an expected profit based on distance travelled, the distance travelled incorporating the ride request into the driver schedule, and
wherein the determining the driver bid is based on the driver preference.

9. The method of claim 1, wherein the client device is at least one of a smartphone, a tablet, a laptop, or a wearable computing device.

10. A system for matching a driver associated with a driver schedule and a rider associated with a ride request including a rider location and a rider destination, the system comprising:
a server configured to communicate the ride request to a client device associated with the driver; and
the client device associated with the driver configured to:
determine a driver bid representing a value associated with incorporating the ride request into the driver schedule, and
communicate, to the server, the driver bid, and
wherein the server is further configured to:
receive one or more other bids from one or more other client devices associated with one or more respective other drivers,
determine a winning bid from the one or more bids, the winning bid being the driver bid, and
communicate, to the client device, an indication to incorporate the ride request into the driver schedule.

11. The system of claim 10, the server further configured to communicate, to the one or more other client devices associated with the one or more respective other drivers, the ride request, wherein the one or more other drivers are all located within a range of the rider location.

12. The system of claim 11, wherein the server is further configured to determine the range of the rider location based on a rider waiting time associated with the rider.

13. The system of claim 10, wherein the value is a profit,
wherein the determining the driver bid includes determining the driver bid based on a pricing model for optimizing profit, and
wherein the winning bid is a bid associated with highest profit.

14. The system of claim 10, wherein the value is a travel distance,
wherein the determining the driver bid includes determining the driver bid based on a pricing model for minimizing travel distance, and
wherein the winning bid is a bid associated with a shortest travel distance.

15. The system of claim 14, wherein the driver schedule includes an existing passenger destination associated with an existing passenger, the existing passenger having an existing passenger preference indicating an expected discount rate based on a detour length associated with incorporating the ride request into the driver schedule, and
wherein the driver bid is based on the existing passenger preference.

16. The system of claim 14, wherein the determining the driver bid based on the pricing model for optimizing profit comprises:
determining the detour length associated with incorporating the ride request into the driver schedule;
determining a cost of incorporating the ride request into the driver schedule based on the existing passenger preference;
determining an additional fare from incorporating the ride request into the driver schedule; and
determining a difference between the additional fare and the cost of incorporating the ride request into the driver schedule.

17. The system of claim 10, wherein the driver is associated with a driver preference indicating an expected profit based on distance travelled, the distance travelled incorporating the ride request into the driver schedule, and
wherein the determining the driver bid is based on the driver preference.

18. The system of claim 10, wherein the client device is at least one of a smartphone, a tablet, a laptop, or a wearable computing device.

19. A computing device for matching a driver and a rider associated with a ride request including a rider location and a rider destination, the computing device configured to:
receive, from a mobile computing device associated with the rider, the ride request;
receive, from a plurality of mobile computing devices each respectively associated with a plurality of drivers, a respective location of each driver;
determine a set of eligible drivers from the plurality of drivers for servicing the rider based on the respective location of each driver of the plurality of drivers;
communicate the ride request to a set of mobile computing devices each respectively associated with the set of eligible drivers;
receive, from each mobile computing device respectively associated with the set of eligible drivers, a respective driver bid;
determine a winning driver bid associated with a winning driver; and
communicate, to a mobile computing device associated with the winning driver, an indication to incorporate the ride request into a driver schedule associated with the winning driver.

20. The computing device of claim 19, wherein the determining the set of eligible drivers comprises:
determining a range of the rider based on a rider waiting time associated with the rider and the rider location, and
determining whether a particular driver from the plurality of drivers is located within the range based on the location of the particular driver.
